(19) United States
(12) Patent Application Publication
(10) Pub. No.: US 2018/0100927 A1
(43) Pub. Date: Apr. 12, 2018

(54) TWO-DIMENSIONAL MAPPING SYSTEM AND METHOD OF OPERATION

(71) Applicant: FARO Technologies, Inc., Lake Mary, FL (US)

(72) Inventors: Oliver Zweigle, Stuttgart (DE); Aleksej Frank, Stuttgart (DE)

(21) Appl. No.: 15/723,511

(22) Filed: Oct. 3, 2017

Related U.S. Application Data
(60) Provisional application No. 62/407,179, filed on Oct. 12, 2016.

(51) Int. Cl. G01S 17/89; G01S 17/02; G06T 7/73; G06T 11/40

(52) U.S. Cl. CPC G01S 17/89; G01S 17/023; G06T 2207/10028; G06T 11/40; G06T 7/73

(57) ABSTRACT

A method and system for generating a two-dimensional map using a scanning system is provided. The method includes receiving laser scan data, a current two-dimensional environmental map, and a first estimated position and orientation of a scanning system. A set of two-dimensional coordinate data and a set of three-dimensional coordinate data are acquired while moving the scanning system from a first position to a second position. It is determined when a location included in the current two-dimensional environmental map includes new content based on the set of three-dimensional coordinate data. It is determined when a value of the new content is equal to or exceeds a threshold. At least one of the first set of two-dimensional coordinate data and the set of two-dimensional coordinate data are merged into the current two-dimensional environmental map when the value of the new content is equal to or exceeds the threshold.

### CROSS-REFERENCE TO RELATED APPLICATIONS

The present application is a nonprovisional application of U.S. Provisional Application 62/407,179 filed on Oct. 12, 2016, the contents of which are incorporated by reference herein.

### BACKGROUND

The present application is directed to a system for generating a two-dimensional map of an area, such as a building for example, and in particular to a two-dimensional mapping system that accommodates moving objects, such as doors.

Metrology devices, such as a 3D laser scanner time-of-flight (TOF) coordinate measurement devices for example, may be used to generate three dimensional representations of areas, such as buildings for example. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Some systems use the three-dimensional data to generate a two-dimensional map or floor plan of the area being scanned. As the TOF laser scanner is moved, an accurate 2D map of the area (e.g. an as-build floor plan) may be generated. It should be appreciated that this may be used in the planning of construction or remodeling of a building for example. An issue arises when an object moves during the scanning process. In some cases, these systems utilize natural features for registration of data. As such, when an object, such as a door for example, moves during the scanning process, the data subsequently generated for 2D map may not be properly oriented relative to the previously acquired data. The reason for the misorientation of the data is that the systems use features of the door for registration and assume that the natural features are fixed. As a result, the subsequently acquired data may be rotated as shown in FIG. 1.

In the map 20 of FIG. 1, a scan is performed that generates a two-dimensional map of a hallway 22. As the operator opens the door 24 to proceed into the room 26, the system uses the edge of the door as a reference point for registration of the data. As a result, when the room 26 is scanned and the data is combined with that from hallway 22, the room 26 will be rotated on the map relative to the hallway 22, resulting in an improperly oriented room 28.

Accordingly, while existing two-dimensional mapping systems are suitable for their intended purposes, what is needed is a mapping system having certain features of embodiments of the present invention.

### BRIEF DESCRIPTION

According to one aspect of the invention, a method and system for generating a two-dimensional map using a scanning system is provided. The method includes receiving laser scan data, a current two-dimensional environmental map, and a first estimated position and orientation of a scanning system. A set of two-dimensional coordinate data and a set of three-dimensional coordinate data are acquired while moving the scanning system from a first position to a second position. It is determined when a location included in the current two-dimensional environmental map includes new content based on the set of three-dimensional coordinate data. It is determined when a value of the new content is equal to or exceeds a threshold. At least one of the first set of two-dimensional coordinate data and the set of two-dimensional coordinate data are merged into the current two-dimensional environmental map when the value of the new content is equal to or exceeds the threshold.

In a further aspect of the invention, another method and system of generating a two-dimensional map in an area with movable objects is provided. The method comprising: providing a scanning system having a three-dimensional scanner and a two-dimensional scanning system, the scanning system having a mobile platform operable to move the scanning system from a first position to a second position; receiving a current two-dimensional environmental map having a first array of cells corresponding to locations in the area, each of the first array of cells having a first value based on previously acquired scan data, the first array of cells having a first cell with a first value; acquire a set of two-dimensional coordinate data and a set of three-dimensional coordinate data while moving the scanning system from a first position to a second position; generating a new two-dimensional environmental map having a second array of cells, each of the second array of cells having a second value based on the set of two-dimensional coordinate data and the set of three-dimensional coordinate data, the second array of cells having a second cell with a second value; registering the new two-dimensional environmental map to the current two-dimensional environmental map, wherein the second cell corresponds to the same location in real-space as the first cell; determining when the value of the second cell is different than the first cell; determining when the value of the second cell is equal to or exceeds a threshold; and merging the at least one of the first set of two-dimensional coordinate data and the set of two-dimensional coordinate data into the current two-dimensional environmental map when the value of the second cell is equal to or exceeds the threshold.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of a two-dimensional map of an area generated by a prior art mapping system;

FIG. 2 is a perspective view of a measuring system according to an embodiment;

FIG. 3 is a perspective view of a laser scanner in accordance with an embodiment of the invention;

FIG. 4 is a side view of the laser scanner illustrating a method of measurement;

FIG. 5 is a schematic illustration of the optical, mechanical, and electrical components of the laser scanner;

FIG. 6 is a block diagram depicting a measurement system and a processor system according to an embodiment;

FIG. 7 is a schematic representation of a 3D scanner measuring an object from two registration positions according to an embodiment;

FIG. 8 is a schematic representation of a 2D scanner measuring the object from a plurality of intermediate positions according to an embodiment;

FIG. 9 is an illustration of a 2D scanner capturing portions of the object from a plurality of positions according to an embodiment;

FIG. 10 is an illustration of the 2D scanner capturing portions of the object from a plurality of positions, as seen from a frame of reference of the 2D scanner, according to an embodiment;

FIGS. 11A, 11B, and 11C illustrate a method for finding changes in the position and orientation of the 2D scanner over time according to an embodiment;

FIG. 12 is a flow diagram of a method of operating the mapping system;

FIG. 13 is a flow diagram of a method of operating the mapping system; and

FIG. 14A, FIG. 14B and FIG. 14C are illustrations of 2D map data acquired by the system of FIG. 2.

The detailed description explains embodiments of the invention, together with advantages and features, by way of example with reference to the drawings.

### DETAILED DESCRIPTION

The present invention relates to a device that includes a 3D scanner and a 2D scanner working cooperatively to provide automatic registration of 3D scans in environments having moving objects, such as doors for example.

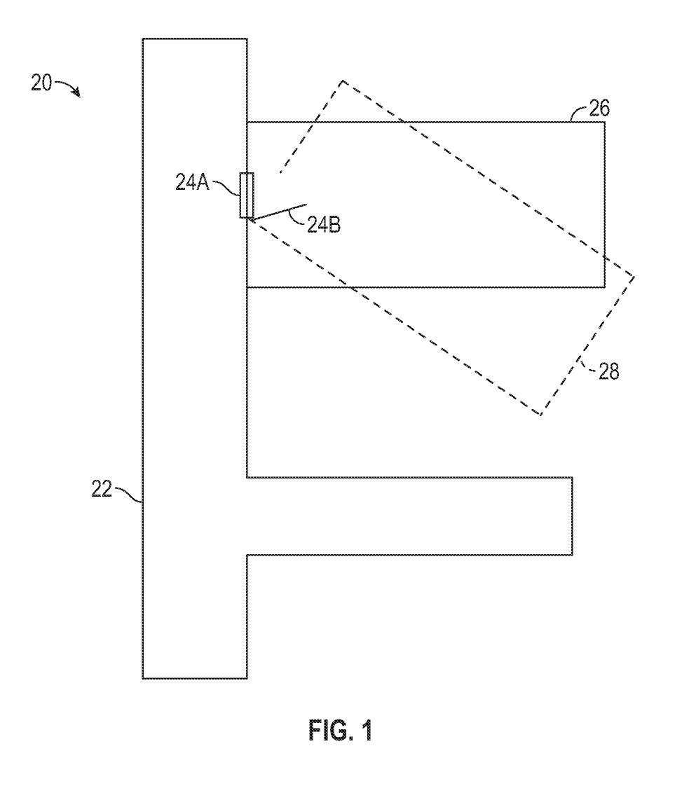

Referring now to FIG. 1, an embodiment is shown of a measurement system 30 that may be used to generate two dimensional maps of an area. The measurement system 30 includes a three-dimensional (3D) scanner 32, a two-dimensional (2D) scanner 34, a processor system 36 and a movable platform 38. The movable platform 38 may include a plurality of wheels 40. In an embodiment, each of the wheels may have a locking mechanism 41 that prevents the mobile platform 38 from moving when the locks are engaged.

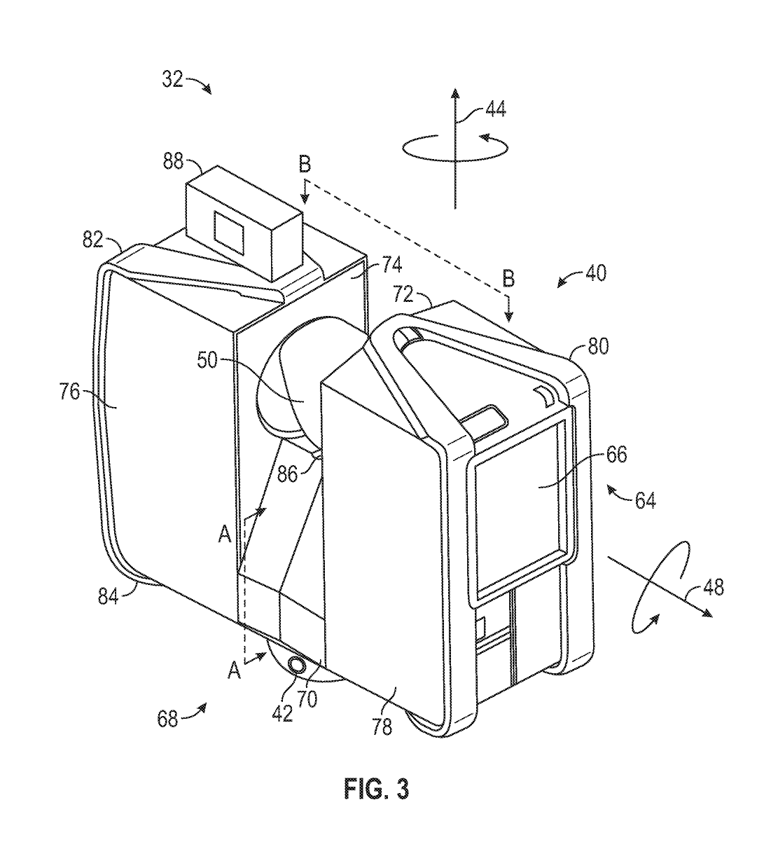

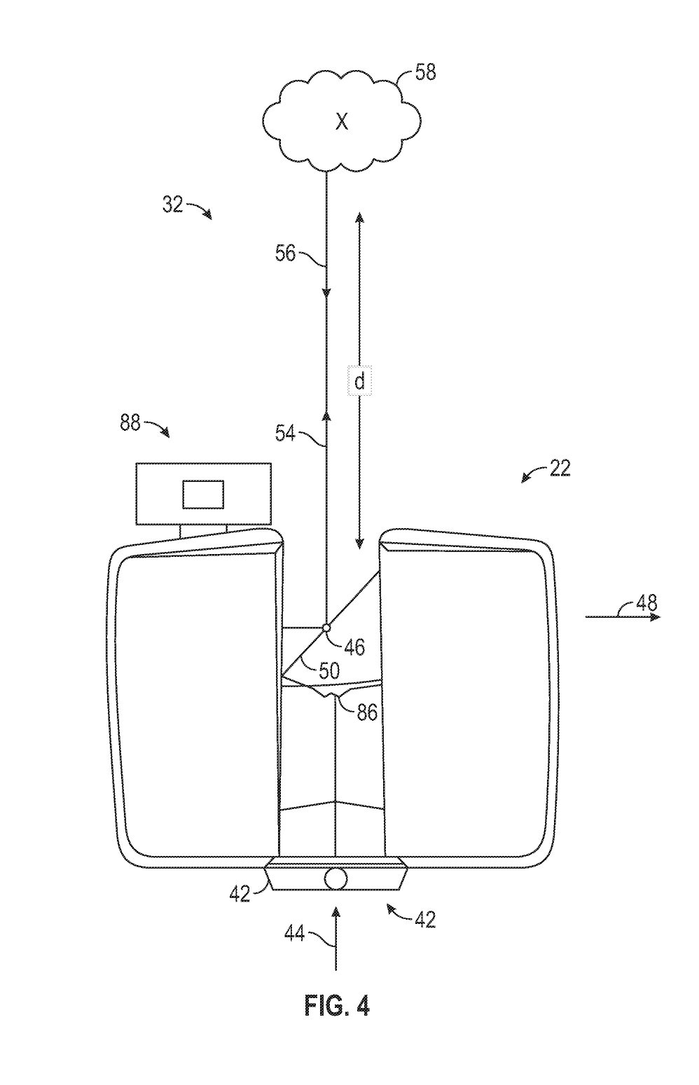

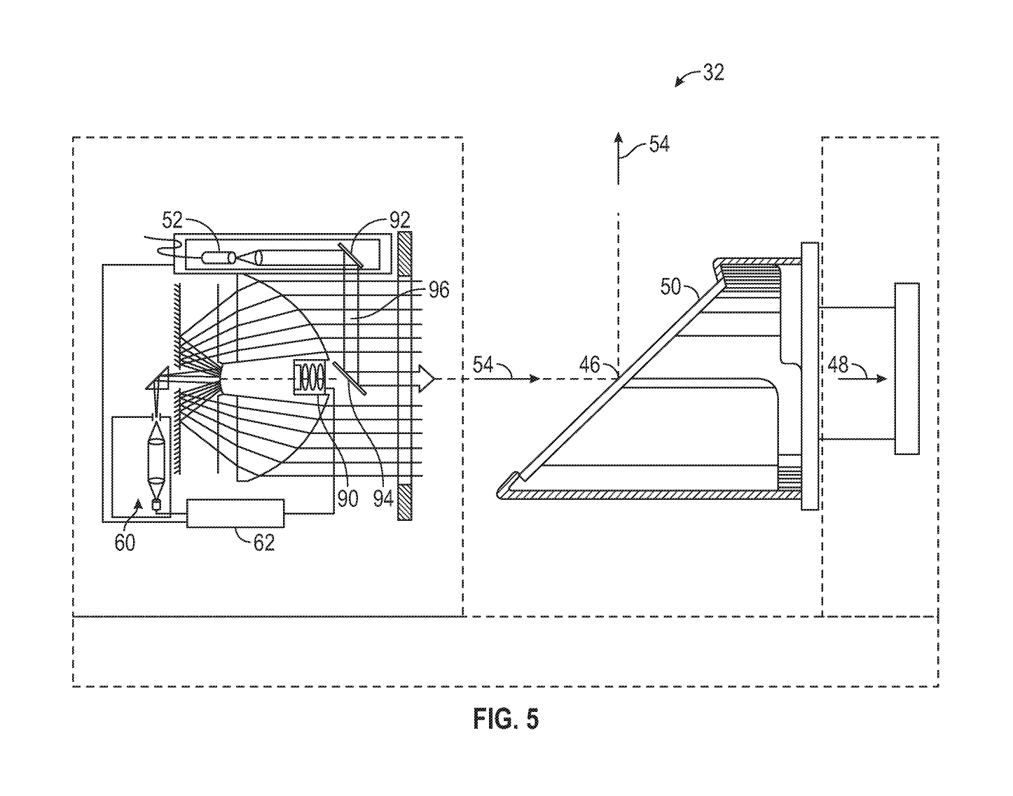

Referring now to FIGS. 3-5, the laser scanner 32 is shown for optically scanning and measuring the environment surrounding the laser scanner 32. The laser scanner 32 has a measuring head 40 and a base 42. The measuring head 40 is mounted on the base 42 such that the laser scanner 32 may be rotated about a vertical axis 44. In one embodiment, the measuring head 40 includes a gimbal point 46 that is a center of rotation about the vertical axis 44 and a horizontal axis 48. The measuring head 40 has a rotary mirror 50, which may be rotated about the horizontal axis 48. The rotation about the vertical axis may be about the center of the base 42. The terms vertical axis and horizontal axis refer to the scanner in its normal upright position. In other words, with the axis 44 extending approximately perpendicular to the floor or ground and the axis 48 being approximately parallel with the floor or ground. It should be appreciated that it is also possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative nomenclature for the vertical axis.

The measuring head 40 is further provided with an electromagnetic radiation emitter, such as light emitter 52, for example, that emits an emitted light beam 54. In one embodiment, the emitted light beam 54 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 54 may be amplitude or intensity modulated, for example, with a sinusoidal waveform or with a rectangular waveform. The emitted light beam 54 is emitted by the light emitter 52 onto the rotary mirror 50, where it is deflected to the environment. A reflected light beam 56 is reflected from the environment by an object 58. The reflected or scattered light is intercepted by the rotary mirror 50 and directed into a light receiver 60. The directions of the emitted light beam 54 and the reflected light beam 56 result from the angular positions of the rotary mirror 50 and the measuring head 40 about the axes 44, 48 respectively. These angular positions in turn depend on the corresponding rotary drives or motors.

Coupled to the light emitter 52 and the light receiver 60 is a controller 62. The controller 62 determines, for a multitude of measuring points X, a corresponding number of distances d between the laser scanner 32 and the points X on object 58. The distance to a particular point X is determined based at least in part on the speed of light in air through which electromagnetic radiation propagates from the device to the object point X. In one embodiment the phase shift of modulation in light emitted by the laser scanner 32 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 50 about axis 25 relatively quickly while rotating the measuring head 22 about axis 23 relatively slowly, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 42 rests in this local stationary reference system.

In addition to measuring a distance d from the gimbal point 46 to an object point X, the scanner 30 may also collect gray-scale information related to the received optical power (equivalent to the term “brightness.”) The gray-scale value may be determined at least in part, for example, by integration of the bandpass-filtered and amplified signal in the light receiver 60 over a measuring period attributed to the object point X.

The measuring head 40 may include a display device 64 integrated into the laser scanner 32. The display device 64 may include a graphical touch screen 66, as shown in FIG. 3, which allows the operator to set the parameters or initiate the operation of the laser scanner 32. For example, the screen 66 may have a user interface that allows the operator to provide measurement instructions to the device, and the screen may also display measurement results.

The laser scanner 32 includes a carrying structure 68 that provides a frame for the measuring head 40 and a platform for attaching the components of the laser scanner 32. In one embodiment, the carrying structure 68 is made from a metal such as aluminum. The carrying structure 68 includes a traverse member 70 having a pair of walls 72, 74 on opposing ends. The walls 72, 74 are parallel to each other and extend in a direction opposite the base 42. Shells 76, 78 are coupled to the walls 72, 74 and cover the components of the laser scanner 32. In the exemplary embodiment, the shells 76, 78 are made from a plastic material, such as polycarbonate or polyethylene for example. The shells 76, 78 cooperate with the walls 72, 74 to form a housing for the laser scanner 32.

On an end of the shells 76, 78 opposite the walls 72, 74 a pair of yokes 80, 82 are arranged to partially cover the respective shells 76, 78. In the exemplary embodiment, the yokes 80, 82 are made from a suitably durable material, such as aluminum for example, that assists in protecting the shells 76, 78 during transport and operation. The yokes 80, 82 each includes a first arm portion 84 that is coupled, such as with a fastener for example, to the traverse 70 adjacent the base 42. The arm portion 84 for each yoke 80, 82 extends from the traverse 70 obliquely to an outer corner of the respective shell 76, 78. From the outer corner of the shell, the yokes 80, 82 extend along the side edge of the shell to an opposite outer corner of the shell. Each yoke 80, 82 further includes a second arm portion that extends obliquely to the walls 72, 74. It should be appreciated that the yokes 80, 82 may be coupled to the traverse 70, the walls 72, 74 and the shells 76, 78 at multiple locations.

The pair of yokes 80, 82 cooperate to circumscribe a convex space within which the two shells 76, 78 are arranged. In the exemplary embodiment, the yokes 80, 82 cooperate to cover all of the outer edges of the shells 76, 78, while the top and bottom arm portions project over at least a portion of the top and bottom edges of the shells 76, 78. This provides advantages in protecting the shells 76, 78 and the measuring head 40 from damage during transportation and operation. In other embodiments, the yokes 80, 82 may include additional features, such as handles to facilitate the carrying of the laser scanner 32 or attachment points for accessories for example.

On top of the traverse 70, a prism 86 is provided. The prism 86 extends parallel to the walls 72, 74. In the exemplary embodiment, the prism 86 is integrally formed as part of the carrying structure 68. In other embodiments, the prism 86 is a separate component that is coupled to the traverse 70. When the mirror 50 rotates, during each rotation the mirror 50 directs the emitted light beam 54 onto the traverse 70 and the prism 86. Due to non-linearities in the electronic components, for example in the light receiver 60, the measured distances d may depend on signal strength, which may be measured in optical power entering the scanner or optical power entering optical detectors within the light receiver 56, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 60. Since the prism 86 is at a known distance from the gimbal point 46, the measured optical power level of light reflected by the prism 86 may be used to correct distance measurements for other measured points, thereby allowing for compensation to correct for the effects of environmental variables such as temperature. In the exemplary embodiment, the resulting correction of distance is performed by the controller 62.

In an embodiment, the base 42 is coupled to a swivel assembly (not shown) such as that described in commonly owned U.S. Pat. No. 8,705,012 (′012), which is incorporated by reference herein. The swivel assembly is housed within the carrying structure 68 and includes a motor that is configured to rotate the measurement head 40 about the axis 44.

An auxiliary image acquisition device 88 may be a device that captures and measures a parameter associated with the scanned volume or the scanned object and provides a signal representing the measured quantities over an image acquisition area. The auxiliary image acquisition device 88 may be, but is not limited to, a pyrometer, a thermal imager, an ionizing radiation detector, or a millimeter-wave detector.

In an embodiment, a camera (first image acquisition device) 90 is located internally to the scanner 30 and may have the same optical axis as the 3D scanner device. In this embodiment, the first image acquisition device 90 is integrated into the measuring head 40 and arranged to acquire images along the same optical pathway as emitted light beam 54 and reflected light beam 56. In this embodiment, the light from the light emitter 52 reflects off a fixed mirror 92 and travels to dichroic beam-splitter 94 that reflects the light 96 from the light emitter 52 onto the rotary mirror 50. The dichroic beam-splitter 94 allows light to pass through at wavelengths different than the wavelength of light 96. For example, the light emitter 52 may be a near infrared laser light (for example, light at wavelengths of 780 nm or 1150 nm), with the dichroic beam-splitter 94 configured to reflect the infrared laser light while allowing visible light (e.g., wavelengths of 400 to 700 nm) to transmit through. In other embodiments, the determination of whether the light passes through the beam-splitter 94 or is reflected depends on the polarization of the light. The digital camera 90 acquires 2D photographic images of the scanned area to capture color data (texture) to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 44 and by steering the mirror 50 about the axis 48.

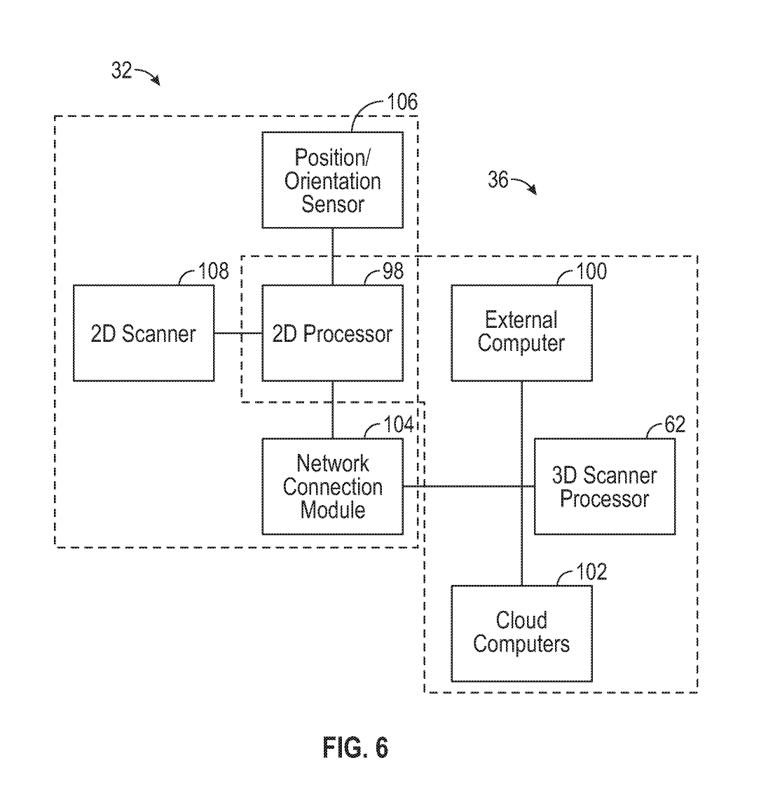

Referring now to FIG. 6, the processor system 36 includes one or more processing elements that may include a 3D scanner processor (controller) 62, 2D processor 98, an external computer 100, and a cloud computer 102. It should be appreciated that cloud computer 102 refers to one or more computing devices connected for communications via a network, such as the internet for example. The computing devices may be arranged in a distributed arrangement to operate cooperatively to process data from the processor system 36. The processors may be microprocessors, field programmable gate arrays (FPGAs), digital signal processors (DSPs), and generally any device capable of performing computing functions. The one or more processors have access to memory (volatile or nonvolatile) for storing information. In an embodiment illustrated in FIG. 6, the controller 62 represents one or more processors distributed throughout the 3D scanner. Also included in the embodiment of FIG. 62 are 2D processor 98 for the 2D scanner 34, an external computer 100, and one or more cloud computers 102 for remote computing capability. In another embodiment, only one or more of the processors 62, 98, 100, and 102 may be combined or integrated within the processor system. Communication between the processors may be through a wired, wireless, or a combination of wired and wireless data connection or medium. In an embodiment, the connection between the processor 98 of the 2D scanner 34 and the processor 62 of the 3D scanner 30 is made by IEEE 802.11 (Wi-Fi) through the network connection module 104. In an embodiment, scan results are uploaded after each scanning session to a remote network (e.g. a cloud or distributed network) via a local area network or a wide area network for storage and future use.

The 2D scanner 36 measures 2D coordinates in a plane. In most cases, it does this by steering light within a plane to illuminate object points in the environment. It collects the reflected (scattered) light from the object points to determine 2D coordinates of the object points in the 2D plane. In an embodiment, the 2D scanner scans a spot of light over an angle while at the same time measuring an angle value and corresponding distance value to each of the illuminated object points.

Examples of 2D scanner assemblies 108 include but are not limited to 2D scanners from the Sick LMS100 product family and 2D scanners from Hoyuko such as the Hoyuko models URG-04LX-UG01 and UTM-30LX. The scanners in the Sick LMS100 family measure angles over a 270 degree range and over distances up to 20 meters. The Hoyuko model URG-04LX-UG01 is a low-cost 2D scanner that measures angles over a 240 degree range and distances up to 4 meters. The Hoyuko model UTM-30LX is a 2D scanner that measures angles over a 270 degree range and to distances up to 30 meters. Many other types of 2D scanners are also commercially available.

In an embodiment, an optional position/orientation sensor 106 in the 2D scanner accessory 32 may include inclinometers (accelerometers), gyroscopes, magnetometers, and altimeters. Usually devices that include one or more of an inclinometer and gyroscope are referred to as an inertial measurement unit (IMU). In some cases, the term IMU is used in a broader sense to include a variety of additional devices that indicate position and/or orientation—for example, magnetometers that indicate heading based on changes in magnetic field direction relative to the earth's magnetic north and altimeters that indicate altitude (height). An example of a widely used altimeter is a pressure sensor. By combining readings from a combination of position/orientation sensors with a fusion algorithm that may include a Kalman filter, relatively accurate position and orientation measurements can be obtained using relatively low-cost sensor devices.

The moveable platform 38 enables the 3D measuring device 32 and 2D scanner 34 to be moved from place to place, typically along a floor that is approximately horizontal. In an embodiment, the moveable platform 38 is a tripod that includes wheels 40. In an embodiment, the wheels 40 may be locked in place using wheel brakes 41. In another embodiment, the wheels 40 are retractable, enabling the tripod to sit stably on three feet attached to the tripod. In another embodiment, the tripod has no wheels but is simply pushed or pulled along a surface that is approximately horizontal, for example, a floor. In another embodiment, the optional moveable platform 38 is a wheeled cart that may be hand pushed/pulled or motorized.

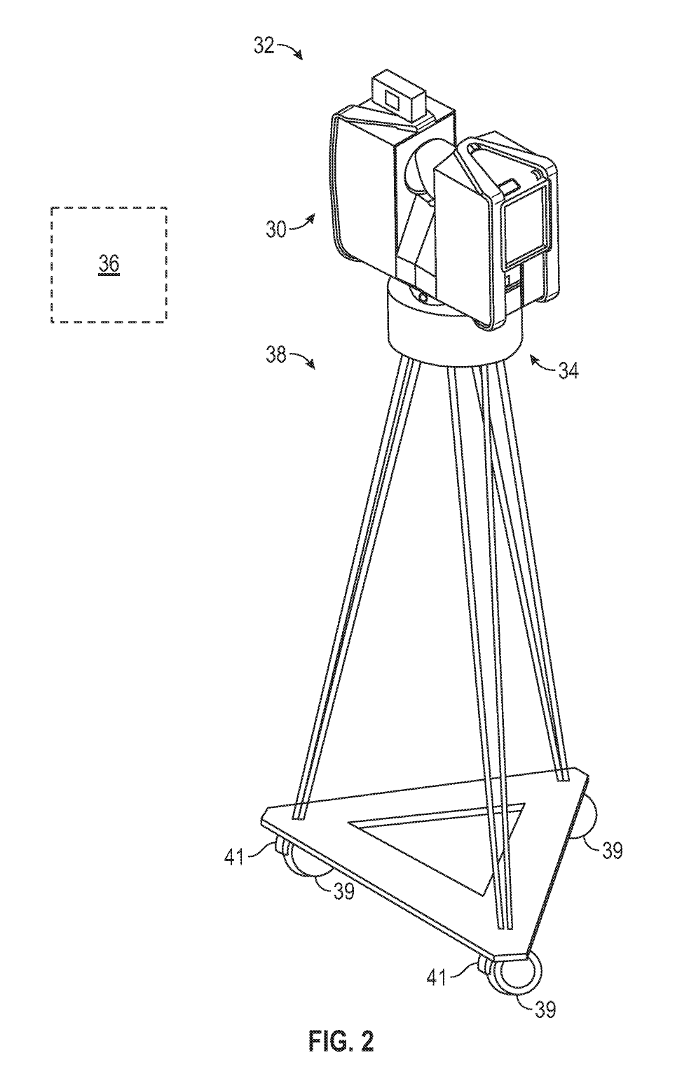

In an embodiment, the 2D scanner 34 is mounted between the moveable platform 38 and the 3D scanner 30 as shown in FIG. 2. In another embodiment, the 2D scanner 34 is integrated into the 3D scanner 32. In another embodiment, the 2D scanner 34 is mounted on the moveable platform 38, for example, on a leg of a tripod or between the legs of the tripod. In another embodiment, the 2D scanner 34 is mounted on the body of the 3D scanner, for example, in a position similar to that of image acquisition device 88 in FIG. 3. In another embodiment, the 2D scanner assembly 108 is attached to a leg of a tripod while other parts of the 2D scanner 32 are internal to the 3D scanner 32.

In an embodiment, the 2D scanner assembly 108 is oriented so as to scan a beam of light over a range of angles in a horizontal plane. At instants in time the 2D scanner assembly 108 returns an angle reading and a corresponding distance reading to provide 2D coordinates of object points in the horizontal plane. In completing one scan over the full range of angles, the 2D scanner returns a collection of paired angle and distance readings. As the 3D measuring device 32 is moved from place to place, the 2D scanner 34 continues to return 2D coordinate values. These 2D coordinate values are used to locate the position of the 3D scanner 30 at each stationary registration position, thereby enabling more accurate registration.

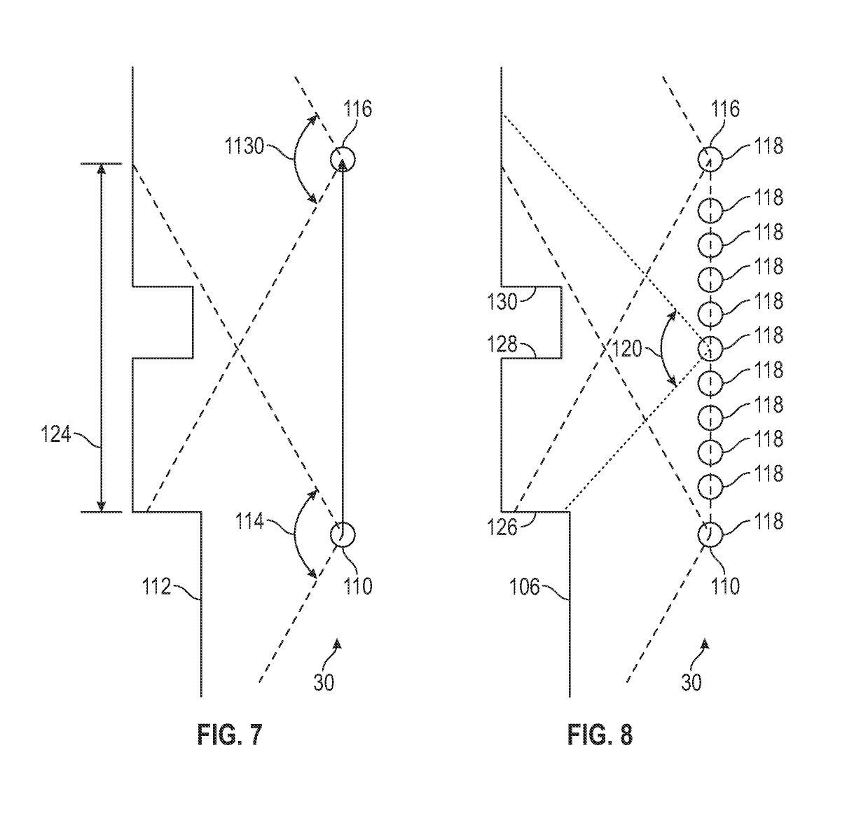

Referring now to FIG. 7, a movement of the system 30 from a first registration position 110 in front of an object 112 that is to be measured. The object 112 might for example be a wall in a room. In an embodiment, the system 30 is brought to a stop and is held in place with brakes, which in an embodiment are brakes 41 on wheels 39. The 3D scanner 30 in system 30 takes a first 3D scan of the object 112. In an embodiment, the 3D scanner 30 may, if desired, obtain 3D measurements in all directions except in downward (e.g. toward the floor/ground) directions blocked by the structure of the system 30. However, in the example of FIG. 7, in which 3D scanner 32 measures a long, mostly flat structure 112, a smaller effective FOV 114 may be selected to provide a more face-on view of features on the structure.

When the first 3D scan is completed, the processor system 36 receives a signal indicating that 2D scan data is being collected. This signal may come from the position/orientation sensor 106 in response to the sensor 106 detecting a movement of the system 32 for example. The signal may be sent when the brakes 41 are released, or it may be sent in response to a command sent by an operator. The 2D scanner 34 may start to collect data when the system 30 starts to move, or it may continually collect 2D scan data, even when the 2D scanner 32 is stationary. In an embodiment, the 2D scanner data is sent to the processor system 36 as it is collected.

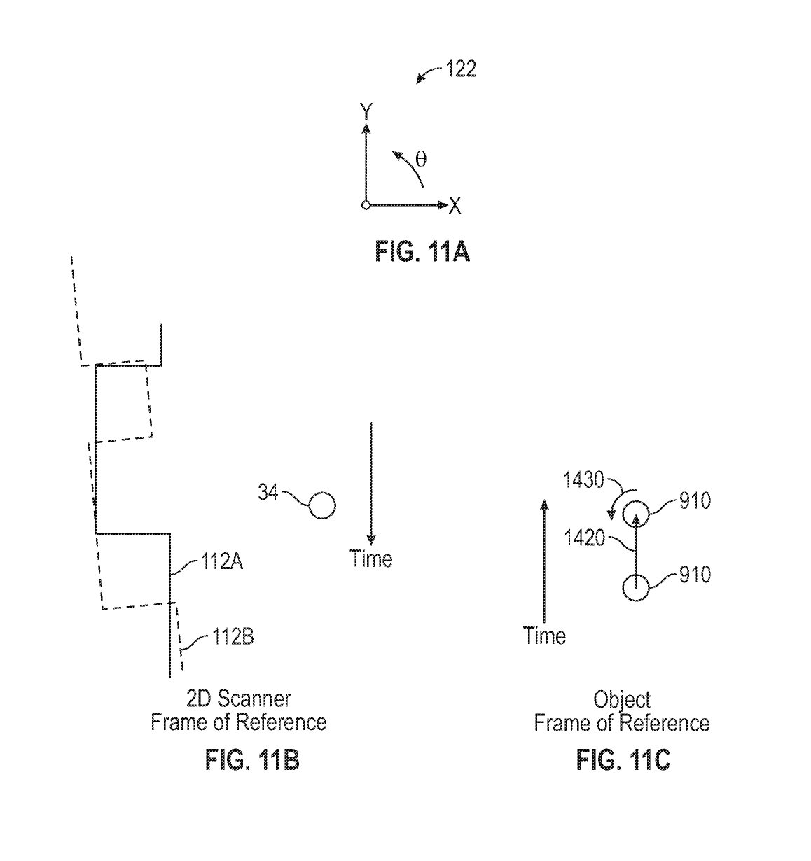

In an embodiment, the 2D scanner 34 measures as the system 30 is moved toward the second registration position 116. In an embodiment, 2D scan data is collected and processed as the scanner passes through a plurality of 2D measuring positions 118. At each measuring position 118, the 2D scanner 34 collects 2D coordinate data over an effective FOV 120 (FIG. 8). Using methods described in more detail below, the processor system 36 uses 2D scan data from the plurality of 2D scans at positions 118 to determine a position and orientation of the 3D scanner 30 at the second registration position 116 relative to the first registration position 110, where the first registration position and the second registration position are known in a 3D coordinate system common to both. In an embodiment, the common coordinate system is represented by 2D Cartesian coordinates x, y and by an angle of rotation 9 relative to the x or y axis. In an embodiment, the x and y axes lie in the plane of the scanner and may be further based on a direction of a “front” of the 2D scanner 34. An example of such an (x, y, θ) coordinate system is the coordinate system 122 of FIG. 11A.

On the object 112, there is a region of overlap 124 between the first 3D scan (collected at the first registration position 110) and the second 3D scan (collected at the second registration position 116). In the overlap region 124 there are registration targets (which may be natural features of the object 112) that are seen in both the first 3D scan and the second 3D scan. A problem that often occurs in practice is that, in moving the system 20 from the first registration position 110 to the second registration position 116, the processor system 36 loses track of the position and orientation of the system 20 and hence is unable to correctly associate the registration targets in the overlap regions to enable the registration procedure to be performed with the desired reliably. By using the succession of 2D scans, the processor system 36 is able to determine the position and orientation of the system 20 at the second registration position 116 relative to the first registration position 112. This information enables the processor system 36 to correctly match registration targets in the region of overlap 124, thereby enabling the registration procedure to be properly completed.

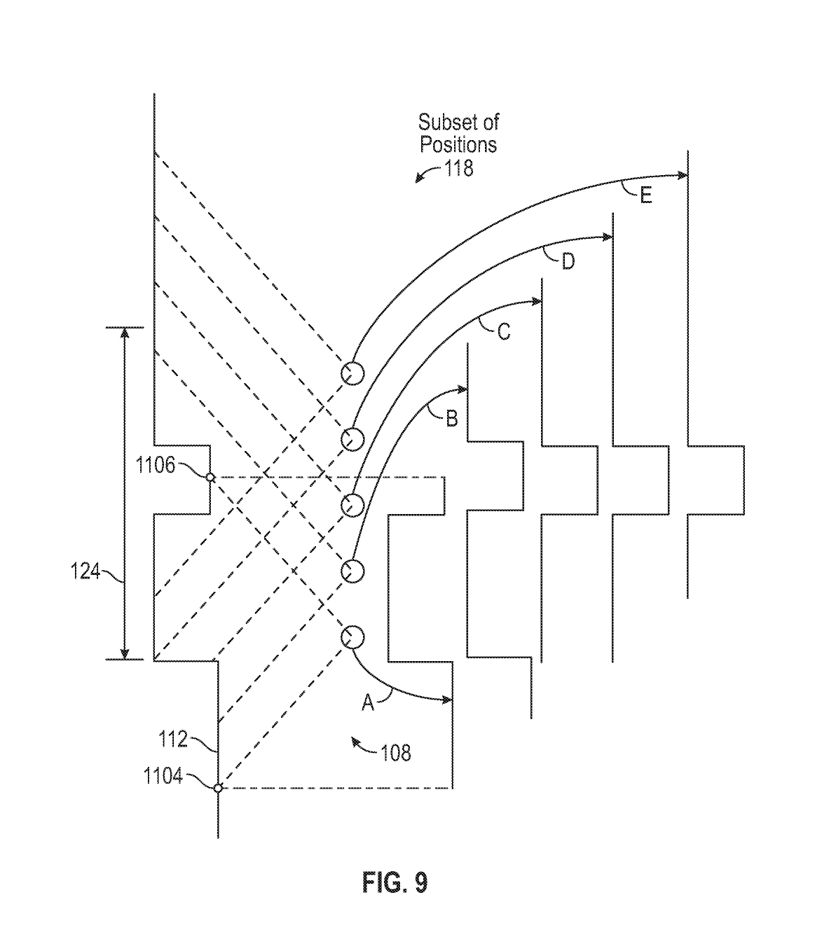

FIG. 9 shows the 2D scanner 34 collecting 2D scan data at selected positions 118 over an effective FOV 120. At different positions 118, the 2D scanner assembly 108 captures a portion of the object 112 marked A, B, C, D, and E. FIG. 9 shows 2D scanner 34 moving in time relative to a fixed frame of reference of the object 112.

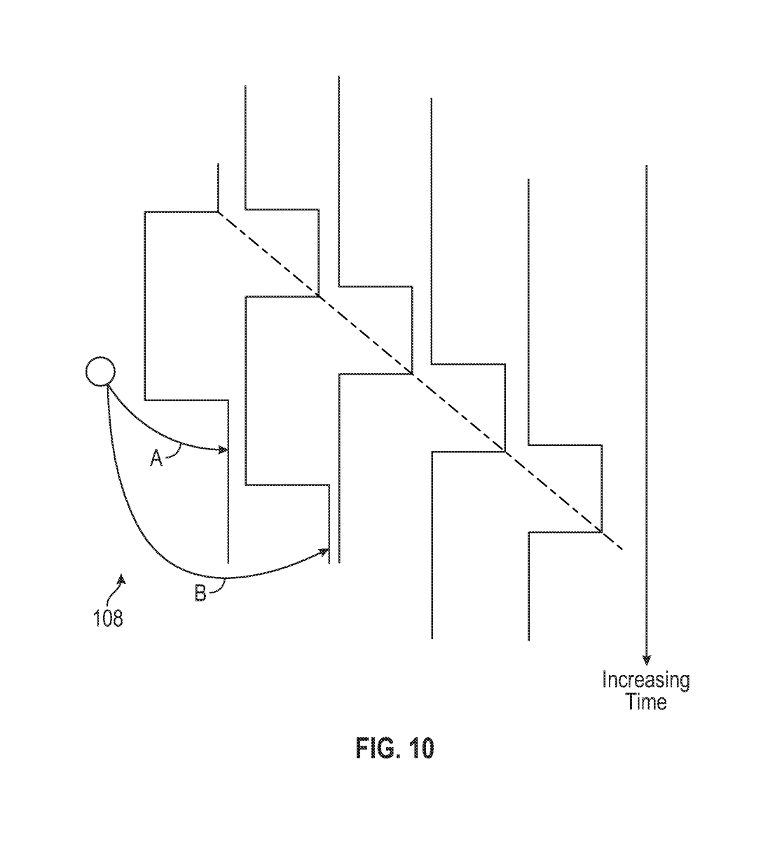

FIG. 10 includes the same information as FIG. 9 but shows it from the frame of reference of the 2D scanner assembly 108 rather than the frame of reference of the object 112. This figure makes clear that in the 2D scanner frame of reference, the position of features on the object change over time. Hence it is clear that the distance traveled by the 2D scanner 34 can be determined from the 2D scan data sent from the 2D scanner assembly 108 to the processor system 36. As will be discussed in more detail below, where the position of the features remains fixed (e.g. a corner of a nonmovable structure), the features may be used to register the data. However, where a feature, such as a door for example, is scanned in one position and subsequently moved, this may cause issues with the registration, and particular with the orientation of the data acquired after movement. As discussed herein, one or more embodiments solve the issue of registering data that includes moved or movable features/structures.

FIG. 11A shows a coordinate system that may be used in FIGS. 11B and 11C. In an embodiment, the 2D coordinates x and y are selected to lie on the plane of the 2D scanner 34. The angle 9 is selected as a rotation angle relative to an axis such as x or y. FIGS. 11B, 11C represent a realistic case in which the 2D scanner 34 is moved not exactly on a straight line, for example, nominally parallel to the object 112, but also to the side. Furthermore, the 2D scanner 34 may be rotated as it is moved.

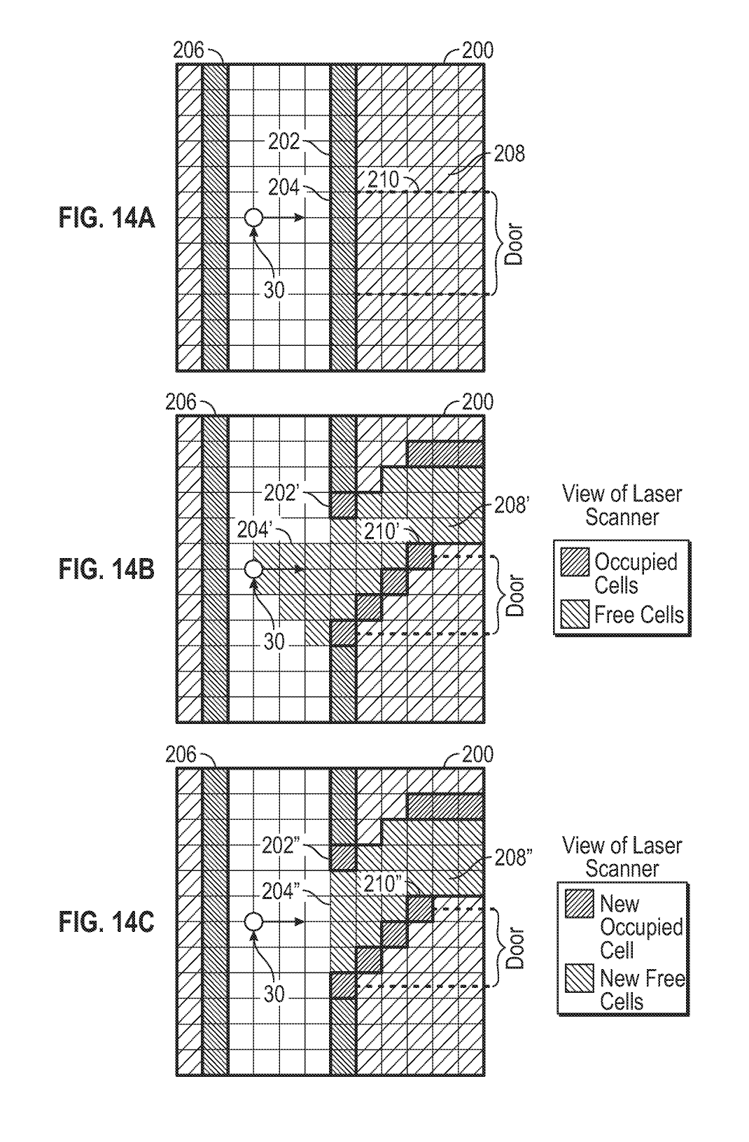

FIG. 11B shows the movement of the object 112 as seen from the frame of reference of the 2D scanner 34. In the 2D scanner frame of reference (that is, as seen from the 2D scanner's point of view), the object 112 is moving while the 2D scanner 34 is fixed in place. In this frame of reference, the portions of the object 112 seen by the 2D scanner 34 appear to translate and rotate in time. The 2D scanner assembly 108 provides a succession of such translated and rotated 2D scans to the processor system 36. In the example shown in FIG. 11A and FIG. 11B, the scanner translates in the +y direction by a distance 1420 shown in FIG. 14B and rotates by an angle 1430, which in this example is +5 degrees. Of course, the scanner could equally well have moved in the +x or −x direction by a small amount. To determine the movement of the 2D scanner 34 in the x, y, θ directions, the processor system 36 uses the data recorded in successive scans as seen in the frame of reference of the 2D scanner 34, as shown in FIG. 11B. In an embodiment, the processor system 36 performs a best-fit calculation using methods known in the art to match the two scans or features in the two scans as closely as possible.

As the 2D scanner 34 takes successive 2D measurements and performs best-fit calculations, the processor system 36 keeps track of the translation and rotation of the 2D scanner 34, which is the same as the translation and rotation of the 3D scanner 32 and the system 30. In this way, the processor system 36 is able to accurately determine the change in the values of x, y, θ as the system 30 moves from the first registration position 110 to the second registration position 116.

It should be appreciated that the processor system 36 determines the position and orientation of the system 30 based on a comparison of the succession of 2D scans and not on fusion of the 2D scan data with 3D scan data provided by the 3D scanner 32 at the first registration position 110 or the second registration position 116.

Instead, in an embodiment, the processor system 36 is configured to determine a first translation value, a second translation value, and a first rotation value that, when applied to a combination of the first 2D scan data and second 2D scan data, results in transformed first 2D data that matches (or matches within a threshold) transformed second 2D data as closely (or within a predetermined threshold) as possible according to an objective mathematical criterion. In general, the translation and rotation may be applied to the first scan data, the second scan data, or to a combination of the two. For example, a translation applied to the first data set is equivalent to a negative of the translation applied to the second data set in the sense that both actions produce the same match in the transformed data sets. In an embodiment, an example of an “objective mathematical criterion” is that of minimizing the sum of squared residual errors for those portions of the scan data judged to overlap. In another embodiment, the objective mathematical criterion may involve a matching of multiple features identified on the object. For example, such features might be the edge transitions 126, 128, and 130 shown in FIG. 8. The mathematical criterion may involve processing of the raw data provided by the 2D scanner 32 to the processor system 36, or it may involve a first intermediate level of processing in which features are represented as a collection of line segments using methods that are known in the art, for example, methods based on the Iterative Closest Point (ICP). Such a method based on ICP is described in Censi, A., “An ICP variant using a point-to-line metric,” IEEE International Conference on Robotics and Automation (ICRA) 2008.

In an embodiment, the first translation value is dx, the second translation value is dy, and the first rotation value dθ. If the first scan data is collected with the 2D scanner assembly 108 having translational and rotational coordinates (in a reference coordinate system) of (x₁, y₁, θ₁), then when the second 2D scan data is collected at a second location the coordinates are given by (x₂, y₂, θ₂)=(x₁+dx, y₁+dy, θ₁+dθ). In an embodiment, the processor system 36 is further configured to determine a third translation value (for example, dz) and a second and third rotation values (for example, pitch and roll). The third translation value, second rotation value, and third rotation value may be determined based at least in part on readings from the position/orientation sensor 106.

The 2D scanner 34 acquires 2D scan data at the first registration position 110 and more 2D scan data at the second registration position 116. In some cases, these scans may suffice to determine the position and orientation of the system 30 at the second registration position 116 relative to the first registration position 110. In other cases, the two sets of 2D scan data are not sufficient to enable the processor system 36 to accurately determine the first translation value, the second translation value, and the first rotation value. This problem may be avoided by collecting 2D scan data at intermediate scan positions 118. In an embodiment, the 2D scan data is acquired and processed at regular intervals, for example, once per second. In this way, features of the object 112 are easily identified in successive 2D scans acquired at intermediate scan positions 118. If more than two 2D scans are obtained, the processor system 36 may choose to use the information from all the successive 2D scans in determining the translation and rotation values in moving from the first registration position 110 to the second registration position 116. In other embodiments, the processor system 36 may be configured to use only the first and last scans in the final calculation, simply using the intermediate 2D scans to ensure desired correspondence of matching features. In some embodiments, accuracy of matching is improved by incorporating information from multiple successive 2D scans.

The first translation value, the second translation value, and the first rotation value are the same for the 2D scanner 34, the 3D scanner 32, and the system 30 since all are fixed relative to each other.

The system 30 is moved to the second registration position 116. In an embodiment, the system 30 is brought to a stop and brakes (such as wheel brakes 41 for example) are locked to hold the system 30 stationary. In another embodiment, the processor system 36 starts the 3D scan automatically when the moveable platform is brought to a stop, for example, by the position/orientation sensor 106 determining the lack of movement. The 3D scanner 32 of system 30 takes a 3D scan of the object 112. This 3D scan is referred to as the second 3D scan to distinguish it from the first 3D scan taken at the first registration position 110.

The processor system 36 applies the already calculated first translation value, the second translation value, and the first rotation value to adjust the position and orientation of the second 3D scan relative to the first 3D scan. This adjustment, which may be considered to provide a “first alignment,” brings the registration targets (which may be natural features in the overlap region 1150) into close proximity. The processor system 950 performs a fine registration in which it makes fine adjustments to the six degrees of freedom of the second 3D scan relative to the first 3D scan. It makes the fine adjustment based on an objective mathematical criterion, which may be the same as or different than the mathematical criterion applied to the 2D scan data. For example, the objective mathematical criterion may be that of reducing or minimizing the sum of squared residual errors for those portions of the scan data judged to overlap. In another embodiment, the objective mathematical criterion may be applied to a plurality of features in the overlap region. The mathematical calculations in the registration may be applied to raw 3D scan data or to geometrical representations of the 3D scan data, for example, by a collection of line segments.

Outside the overlap region 124, the aligned values of the first 3D scan and the second 3D scan are combined in a registered 3D data set. Inside the overlap region, the 3D scan values included in the registered 3D data set are based on some combination of 3D scanner data from the aligned values of the first 3D scan and the second 3D scan.

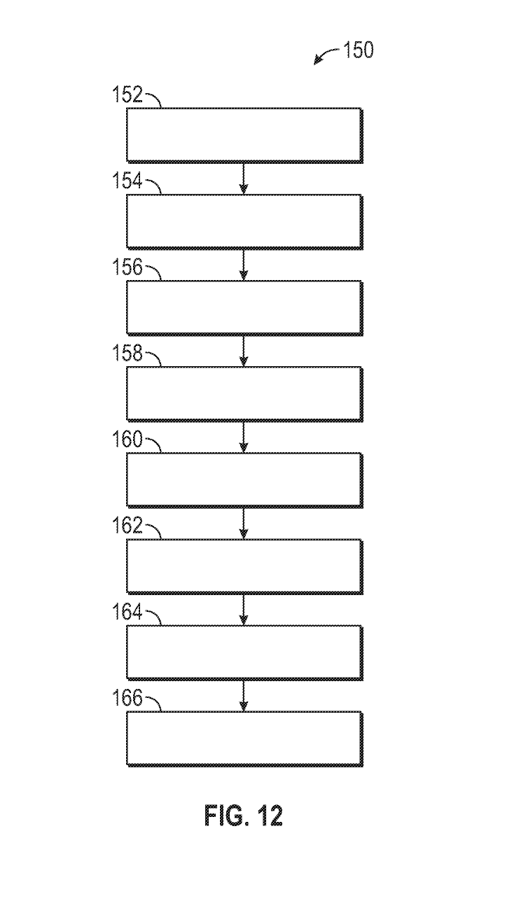

Referring to FIG. 12, an embodiment is shown of a method 150 for measuring and registering 3D coordinates. The method 150 starts in block 152 where a 3D measuring device that includes a processor system, a 3D scanner, a 2D scanner, and a moveable platform is provided. The processor system may include at least one of a 3D scanner controller, a 2D scanner processor, an external computer, and a cloud computer configured for remote network access. Any of these processing elements within the processor system may include a single processor or multiple distributed processing elements, the processing elements being a microprocessor, digital signal processor, FPGA, or any other type of computing device. The processing elements have access to computer memory. The 3D scanner has a first light source, a first beam steering unit, a first angle measuring device, a second angle measuring device, and a first light receiver. The first light source is configured to emit a first beam of light, which in an embodiment is a beam of laser light. The first beam steering unit is provided to steer the first beam of light to a first direction onto a first object point. The beam steering unit may be a rotating mirror such as the mirror 50 or it may be another suitable type of beam steering mechanism. For example, the 3D scanner may contain a base onto which is placed a first structure that rotates about a vertical axis, and onto this structure may be placed a second structure that rotates about a horizontal axis. With this type of mechanical assembly, the beam of light may be emitted directly from the second structure and point in a desired direction. Other types of beam steering mechanisms are possible. In some embodiments, a beam steering mechanism may include one or two motors.

The first direction is determined by a first angle of rotation about a first axis and a second angle of rotation about a second axis. The first angle measuring device is configured to measure the first angle of rotation and the second angle measuring device configured to measure the second angle of rotation. The first light receiver is configured to receive first reflected light, the first reflected light being a portion of the first beam of light reflected by the first object point. The first light receiver is further configured to produce a first electrical signal in response to the first reflected light. The first light receiver is further configured to cooperate with the processor system to determine a first distance to the first object point based at least in part on the first electrical signal, and the 3D scanner is configured to cooperate with the processor system to determine 3D coordinates of the first object point based at least in part on the first distance, the first angle of rotation and the second angle of rotation.

The 2D scanner includes a 2D scanner assembly having a second light source, a second beam steering unit, a third angle measuring device, and a second light receiver. The second light source is configured to emit a second beam of light. The second beam steering unit is configured to steer the second beam of light to a second direction onto a second object point. The second direction is determined by a third angle of rotation about a third axis, the third angle measuring device being configured to measure the third angle of rotation. The second light receiver is configured to receive second reflected light, where the second reflected light is a portion of the second beam of light reflected by the second object point. The second light receiver is further configured to produce a second electrical signal in response to the second reflected light. The 2D scanner is configured to cooperate with the processor system to determine a second distance to the second object point based at least in part on the second electrical signal. The 2D scanner is further configured to cooperate with the processor system to determine 2D coordinates of the second object point based at least in part on the second distance and the third angle of rotation. The moveable platform is configured to carry the 3D scanner and the 2D scanner. The 3D scanner is fixed relative to the 2D scanner, and the moveable platform is configured for motion on a plane perpendicular to the third axis.

The method 150 then proceeds to block 154 where the processor system determines, in cooperation with the 3D scanner, 3D coordinates of a first collection of points on an object surface while the 3D scanner is fixedly located at a first registration position. The method then proceeds to block 156 where the 2D scanner, in cooperation with the processor system, obtains or acquires a plurality of 2D scan sets. In an embodiment, each of the plurality of 2D scan sets is a set of 2D coordinates of points on the object surface collected as the 2D scanner moves from the first registration position to a second registration position. Each of the plurality of 2D scan sets is collected by the 2D scanner at a different position relative to the first registration position.

The method 150 then proceeds to block 158 where the processor system determines a first translation value corresponding to a first translation direction, a second translation value corresponding to a second translation direction, and a first rotation value corresponding to a first orientational axis, wherein the first translation value, the second translation value, and the first rotation value are determined based at least in part on a fitting of the plurality of 2D scan sets according to a first mathematical criterion.

The method 150 then proceeds to block 160 where the processor system determines, in cooperation with the 3D scanner, 3D coordinates of a second collection of points on the object surface while the 3D scanner is fixedly located at the second registration position. The method 150 then proceeds to block 162 where the processor system identifies a correspondence among registration targets present in both the first collection of points and the second collection of points, the correspondence based at least in part on the first translation value, the second translation value, and the first rotation value.

The method 150 then proceeds to block 164 where the 3D coordinates of a registered 3D collection of points are determined based at least in part on a second mathematical criterion, the correspondence among the registration targets, the 3D coordinates of the first collection of points and the 3D coordinates of the second collection of points. The method 150 terminates in block 166 with the 3D coordinates of the registered 3D collection of points being stored in memory.

As discussed herein, the registration of scan data may be adversely impacted by the movement of features in the area being scanned. Referring to FIG. 1, an area with a hallway 22 may be scanned by system 30 to acquire a first data set of coordinate data that is used to generate a 2D map. On the hallway 22 is a door 24A that is scanned as part of the first data set. The operator then proceeds to open the door to position 24B to allow the system 30 to be moved into the room 26 for further scanning. Since the features of the door 24 are used for registering the subsequently acquired coordinate data, the registration methods of prior systems would cause the data set for room 26 to be oriented on an angle relative to the hallway 22.

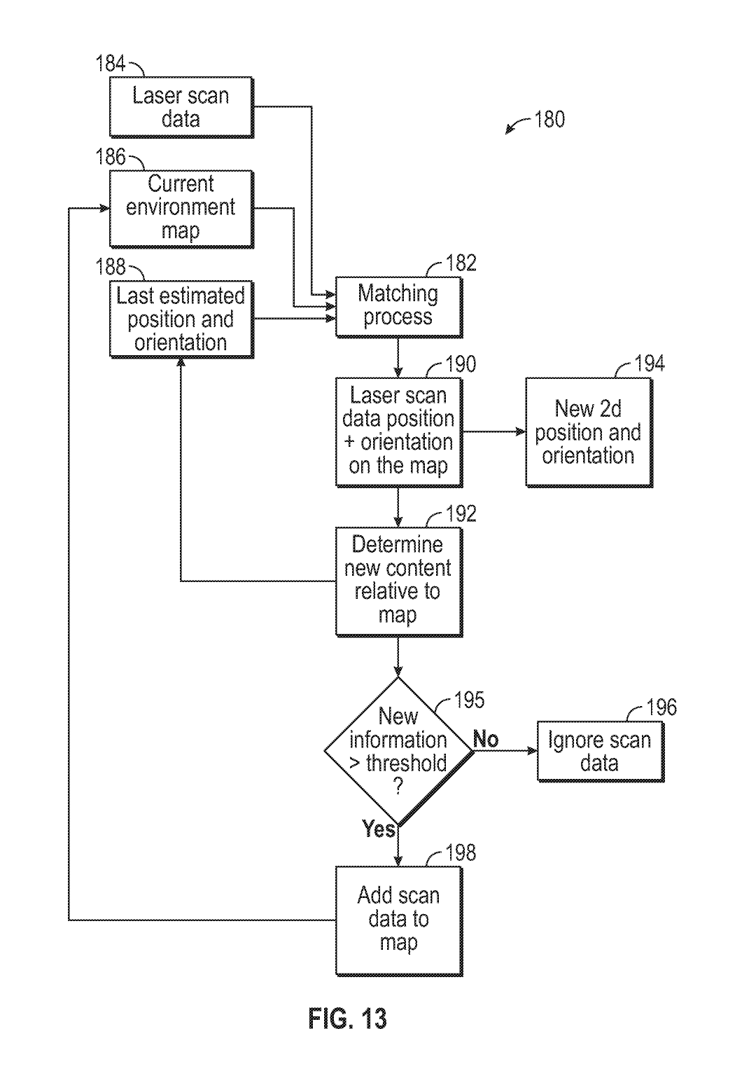

To resolve this issue, the system 30 includes the method 180 as shown in FIG. 13. The method 180 starts in block 182 where laser scan data 184, the current 2D map data 186, and the last estimated position and orientation data 188 for the system 30 are used as inputs to the process for matching or registering the newly acquired coordinate data with the existing coordinate data. In an embodiment, the current 2D map data 186 may be as illustrated in FIG. 14A where the data is map is defined by an array of cells or grid 200.

The grid 200 is superimposed on a representation of area being scanned. Each cell within the grid 200 may have one of three values on the 2D map. A cell may be occupied, such as cell 202 which represents a wall, or cell 204 which represents the door 24. A cell may also be “free,” such as cell 206, meaning no structure or wall was detected by the system 30. Finally, a cell may be “unknown,” such as cell 208 and cell 210, which lies in an area that has not yet been scanned.

In an embodiment, each cell of the grid is 5 centimeters per side. It should be appreciated that this is for exemplary purposes and the claimed invention should not be so limited. In other embodiments, the size of the cell may be user defined.

The method 180 then proceeds to block 190 where the 3D scanner 32 and the 2D scanner 34 acquire additional data, such as by moving the system 30 through the door 24 into the room 26. As the system 30 scans the new area, the method determines the new content or the new map features (e.g. walls) in block 192. In an embodiment, a new second position (e.g. position 116) is recorded in block 194. The new content is illustrated in FIG. 14B, where the new content acquired during the scan is superimposed on the grid 200. It should be appreciated that the new content has not yet been integrated into the 2D map data 186.

Each of the cells in the new content are assigned a value based on the data acquired by the scanner 30 in block 190. The cells may have one of three values, “occupied,” such as cell 202′, “free” cell 204′ and “unknown” cells (areas not scanned). It should be noted that the values of some cells change between the new content and the existing 2D map. For example, cell 204 and cell 204′ each represent the same space but have different values. Cell 204 has an occupied value, while cell 204′ has a “free” value. Other cells, such as cell 208/208′ and 210/210′ have also changed, with cell 208 changing from unknown to free, while cell 210/210′ changes from unknown to occupied.

In block 192, the new content is not yet incorporated into the data set for the existing map. The method 180 then proceeds to query block 195 where it is determined if the information (e.g. the number of changed values, or the amount of changed values) of the new content is larger than a threshold. It should be appreciated that by computing the new information (e.g. the number of changed values, or the amount of changed values) moving objects may be explicitly detected. In an embodiment, after determining that an object is moving, this data maybe integrated into the environment map, so that successive scan registrations can be based on the new, updated environment map and thus reducing the risk of misorientation. In block 195, where the value of a cell in the grid has changed, the method 180 proceeds to block 198 and the new value over-writes the existing value. Where the value of the cell has not changed, the method 180 proceeds to block 196 where new cell value is deleted and the existing cell value is retained. It should be appreciated that in some embodiments, the cell values may not be discrete (e.g. −1, 0, +1) but represent a range of values (−1, −0.9, −0.8, −0.7 . . . 0 . . . +0.7, +0.8, +0.9, +1) depending on the measured data. In these embodiments, a threshold may be defined for determining when a new or old cell value is retained.

In block 198, the new content for the cells where the value changed is merged into the current 2D map. The method 180 loops back to block 186 where the new 2D map data shown in FIG. 14C is used as an input to block 182. It should be appreciated that since the moved object data from the initial scan is not retained (e.g. cell 204), the registration of the new scan data will be oriented correctly relative to the hallway 22 since the moved section (e.g. the cell between 202 and 204) will be based on the final position (e.g. cell 210). In some embodiments, the integration of the new scan data may be performed when the system 30 is moving, which reduces the computational load on the processor system 36. In still further embodiments, the integration of the new scan data is performed only when the system 30 is being moved into an area that has not been previously scanned (e.g. previously “unknown”), to reduce the risk of misestimation.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of generating a two-dimensional map of an environment, the method comprising:
receiving laser scan data;
receiving a current two-dimensional environmental map;
receiving a first estimated position and orientation of a scanning system;
acquire a set of two-dimensional coordinate data and a set of three-dimensional coordinate data while moving the scanning system from a first position to a second position;
determining when a location included in the current two-dimensional environmental map includes new content based on the set of three-dimensional coordinate data;
determining when a value of the new content is equal to or exceeds a threshold; and
merging the at least one of the current set of two-dimensional coordinate data and the set of two-dimensional coordinate data into the current two-dimensional environmental map when the value of the new content is equal to or exceeds the threshold.

2. The method of claim 1, further comprising recording a second estimated position and orientation of the scanning system based at least in part on the set of two-dimensional coordinate data.

3. The method of claim 1, further comprising discarding at least a portion of the set of three-dimensional coordinate data when the value of the new content is less than the threshold.

4. The method of claim 1, further comprising generating a new two-dimensional environmental map based on the set of two-dimensional coordinate data and the set of three-dimensional coordinate data.

5. The method of claim 4, wherein the current two-dimensional environmental map and the new two-dimensional environmental map are each comprised of a plurality of cells, each cell having a cell value.

6. The method of claim 5, wherein the step of determining new content includes comparing a first cell value in the current two-dimensional environmental map with corresponding second cell value in the new two-dimensional environmental map.

7. The method of claim 6, wherein the step of determining new content further includes registering the new two-dimensional environmental map to the current two-dimensional environmental map.

8. A system for generating a two-dimensional map of an area, the system comprising:
a 3D scanner having a first light source;
a 2D scanner having a second light source;
a moveable platform configured to carry the 3D scanner and the 2D scanner, the 3D scanner being fixed relative to the 2D scanner, the moveable platform being movable from a first position to a second position;
one or more processors that are responsive to executing computer readable instructions, the one or more processors being operably coupled to memory, the computer readable instructions comprising:
receiving laser scan data;
receiving from the memory a current two-dimensional environmental map;
receiving from the memory a first estimated position and orientation of a scanning system;
acquire a set of two-dimensional coordinate data with the 2D scanner and a set of three-dimensional coordinate data with the 3D scanner while moving the scanning system from the first position to the second position;
determining when a location included in the current two-dimensional environmental map includes new content based on the set of three-dimensional coordinate data;
determining when a value of the new content is equal to or exceeds a threshold; and
merging the at least one of the current set of two-dimensional coordinate data and the set of two-dimensional coordinate data into the current two-dimensional environmental map when the value of the new content is equal to or exceeds the threshold.

9. The system of claim 8, wherein the executable computer readable instructions further comprise recording a second estimated position and orientation of the scanning system based at least in part on the set of two-dimensional coordinate data.

10. The system of claim 8, wherein the executable computer readable instructions further comprise discarding at least a portion of the set of three-dimensional coordinate data when the value of the new content is less than the threshold.

11. The system of claim 8, wherein the executable computer readable instructions further comprise generating a new two-dimensional environmental map based on the set of two-dimensional coordinate data and the set of three-dimensional coordinate data.

12. The system of claim 11, wherein the current two-dimensional environmental map and the new two-dimensional environmental map are each comprised of a plurality of cells, each cell having a cell value.

13. The system of claim 12, wherein the step of determining new content includes comparing a first cell value in the current two-dimensional environmental map with corresponding second cell value in the new two-dimensional environmental map.

14. The system of claim 6, wherein the step of determining new content further includes registering the new two-dimensional environmental map to the current two-dimensional environmental map.

15. A method of generating a two-dimensional map in an area with movable objects, the method comprising:
providing a scanning system having a three-dimensional scanner and a two-dimensional scanning system, the scanning system having a mobile platform operable to move the scanning system from a first position to a second position;
receiving a current two-dimensional environmental map having a first array of cells corresponding to locations in the area, each of the first array of cells having a first value based on previously acquired scan data, the first array of cells having a first cell with the first value;
acquire a set of two-dimensional coordinate data and a set of three-dimensional coordinate data while moving the scanning system from the first position to the second position;
generating a new two-dimensional environmental map having a second array of cells, each of the second array of cells having a second value based on the set of two-dimensional coordinate data and the set of three-dimensional coordinate data, the second array of cells having a second cell with the second value;
registering the new two-dimensional environmental map to the current two-dimensional environmental map, wherein the second cell corresponds to the same location in real-space as the first cell;
determining when the second value of the second cell is different than the first value of the first cell;
determining when the second value of the second cell is equal to or exceeds a threshold; and
merging the at least one of the current set of two-dimensional coordinate data and the set of two-dimensional coordinate data into the current two-dimensional environmental map when the second value of the second cell is equal to or exceeds the threshold.

16. The method of claim 15, further comprising:
receiving a first estimated position and orientation of the scanning system in the first position;
determining a second estimated position and orientation of the scanning system in the second position; and
wherein the step of registering is based at least in part on the first estimated position and orientation of the scanning system and the second estimated position and orientation of the scanning system.

17. The method of claim 15, further comprising discarding the second value of the second cell when the second value of the new content is less than the threshold.

18. The method of claim 15, wherein the step of merging includes replacing the first value with the second value in the current two-dimensional environmental map.

19. The method of claim 15, further comprising operating the 2D scanner when the scanning system is moving from the first position to the second position.

20. The method of claim 19, further comprising operating the 3D scanner when the scanning system is stopped at the second position.
